(19) United States
(12) Patent Application Publication
(10) Pub. No.: US 2015/0183949 A1
(43) Pub. Date: Jul. 2, 2015

(54) MICROCELLULAR POLYURETHANE COMPOSITION, METHOD OF PREPARATION AND USES THEREOF

(71) Applicant: Bayer MaterialScience AG, Leverkusen (DE)

(72) Inventors: Jianfeng Xu, Shanghai (CN); Sam Torres, Shanghai (CN); John Zhang, Shanghai (CN)

(21) Appl. No.: 14/407,973

(22) PCT Filed: Jun. 14, 2013
(86) PCT No.: PCT/EP2013/062326

§ 371 Date: Dec. 15, 2014

(30) Foreign Application Priority Data
Jun. 15, 2012 (CN) 201210199178.4

(51) Int. Cl. C08J 9/14; C08J 9/12

(52) U.S. Cl. CPC C08J 9/143; C08J 9/127; C08J 2375/04; C08J 2203/182; C08J 2205/044

(57) ABSTRACT

The present invention, which is characterized by the employment of blowing agents comprising fluorinated ethers with a boiling point in the range of from about 0 DEG C to 75° C., pertains to a composition of microcellular polyurethane, a method for preparing the same, and its use in manufacturing shoe materials. Compared to shoe soles made from traditional microcellular polyurethane, in particular those made using 1,1,1,2-tetrafluoroethane (HFC 134a) as the blowing agent, the polyurethane shoe soles prepared according to the present invention exhibit similar shrinkage characteristics, and their linear shrinkage is compatible with the current processing conditions, thus can replace traditional blowing systems comprising 1,1,1,2-tetrafluoroethane (HFC 134a) in shoe manufacturing without the need of changing molds. On the premise of being more environmental-friendly, the present invention also effectively saves production cost for shoe manufacturers.

### FIELD OF THE INVENTION

The present invention relates to compositions and methods for preparing microcellular polyurethane, especially microcellular polyurethane elastomers; and the uses thereof.

### BACKGROUND OF THE INVENTION

Microcellular polyurethane, including microcellular polyurethane elastomers and microcellular polyurethane foams, are usually prepared through the foaming of polyurethane-forming reaction mixtures. The blowing agents employed in such reaction mixtures mainly comprise two types: chemical blowing agents, the most-commonly used being water; and physical blowing agents, such as chloro-fluorocarbon (CFC), hydro chloro fluorocarbon (HCFC), hydro fluoro carbon (HFC) and hydro carbon (HC). Some of the above-mentioned hydrocarbons have been limited or banned in their applications due to the damage to ozone layer or to a potential of causing global warming.

Shoe sole manufacturing is a common application of microcellular polyurethane elastomers. Currently in the shoe manufacturing industry, the widely-used hydro fluoro carbon type of physical blowing agent is 1,1,1,2-tetrafluoroethane (HFC134a), which is a well-known replacement of Freon. After the shoe sole cures and is subsequently cooled (either within the mold or after being demolded), a certain amount of linear shrinkage will occur. For HFC-134a and HFC-134a/water-based formulations, the extent to which this shrinkage occurs is generally repeatable and predictable. Shoe sole molds are constructed a bit larger than the size of the final shoe sole will be, in order to take this shrinkage into account. Typically, this linear shrinkage is in the range of from 0.8 to 1.5%, and is most often from about 1 to 1.25%.

However, the global warming potential of HFC134a (GWP) still reaches 1300. In addition, since its boiling point is −26° C., the requirements on process conditions are stringent when HFC134a is employed as a blowing agent in microcellular shoe sole applications.

It has been found that when water is used to replace HFC-134a as the blowing agent in microcellular shoe sole applications, the linear shrinkage is reduced significantly.

Small differences in linear shrinkage have a very substantial impact on shoe sole manufacturers. Shoes are often made to close tolerances to provide a proper fit and to match the sole correctly with uppers and other components. The difference in shrinkage characteristics between HFC-134a-blown and water-blown systems is great enough that molds which are used for the HFC-134a systems often cannot be used with the water-blown systems. This represents a potentially large expense to shoe manufacturers for producing new molds for use with the new water-blown systems. Shoe manufacturers want to avoid this expense, while using more environmentally-friendly and easier-to-process systems. For this reason, shoe manufacturers strongly desire an alternative microcellular polyurethane system that has shrinkage characteristics very close to those of the HFC-134a systems.

WO2008073267 discloses microcellular polyurethane shoe soles prepared from a reaction mixture that contains water as a blowing agent and an auxiliary selected from one or more of methylal, 1,2-trans-dichloroethene, dioxolane, tertiary butanol and propyl propionate. For mold density in the range of about 400˜700 kg/m³, such a microcellular polyurethane exhibits linear shrinkage in the range of 0.8%˜1.5%, more typically about 1%˜1.25%.

U.S. Pat. No. 5,137,932 discloses using a blowing agent containing at least 10 mol % fluorinated ethers (HFEs) in the preparation of polyurethane foams, in particular rigid foams to reduce their thermal conductivity.

U.S. Pat. No. 5,169,873 discloses using a blowing agent containing a mixture of HFEs and fluoroalkanes in the preparation of polyurethane foams, in particular rigid foams to improve their thermal insulation properties.

The above patents and patent publications are incorporated by reference herein in their entirety.

### SUMMARY OF THE INVENTION

Presently, the blowing system used in polyurethane shoe sole manufacturing often comprises 1,1,1,2-tetrafluoroethane (HFC-134a). HFC-134a has relatively high global warming potential (GWP=1300) and a boiling point of −26° C., not very environmental-friendly and not very easy to process. When the prepared elastomer having a mold density in the range of about 400˜700 kg/m³, the resulted shoe sole generally exhibits linear shrinkage in the range of 0.8%˜1.5%, more typically about 1%˜1.25%

One object of the present invention is to provide a blowing system for making polyurethane elastomers, in particular polyurethane shoe soles. The components of the above blowing system have GWPs lower than that of HFC-134a, and when the prepared elastomer having a mold density in the range of about 150˜900 kg/m³, preferably 200˜800 kg/m³, more preferably 400˜700 kg/m³, the resulted shoe sole generally exhibits linear shrinkage close to that of HFC-134a

Another object of the present invention is to provide a blowing system for making polyurethane elastomers, in particular polyurethane shoe soles. The components of the above blowing system have boiling points higher than that of HFC-134a, particularly suitable higher than room temperature, and when the prepared elastomer having a mold density in the range of about 150˜900 kg/m³, preferably 200˜800 kg/m³, more preferably 400˜700 kg/m³, the resulted shoe sole generally exhibits linear shrinkage close to that of HFC-134a.

In one aspect, the present invention discloses a composition for making microcellular polyurethane, in particular microcellular polyurethane elastomers. The composition comprises:
a) an isocyanate with a NCO content of about 5 wt. %-30 wt. %, based on 100% by weight of the isocyanate;
b) a polyol having a functionality of 1-5, and a number average molecular weight of about 1000-12000;
c) optionally catalyst; and
d) a blowing agent, comprising a fluorinated ether of formula (I):

X—O—Y (I)

wherein, X comprises fluorinated alkyl group of 1-6 carbon atoms, Y is independently selected from alkyl group of 1-2 carbons or fluorinated alkyl group of 1-2 carbons;

wherein a boiling point of said fluorinated ether is in the range of about 0° C.-75° C.

In another aspect, the present invention discloses a composition for making microcellular polyurethane, in particular microcellular polyurethane elastomers, comprising:
a) an isocyanate with a NCO content of about 15 wt. %-25 wt. %, based on 100% by weight of the isocyanate;
b) a polyol having a functionality of 2-3, and a number average molecular weight of about 2000-7000;
c) optionally catalysts, such as amine catalysts, organotin catalysts or their mixtures;
d) a blowing agent comprising 1,1,2,2-tetrafluoroethyl methyl ether, 1,1,2,2-tetrafluoroethyl-2′,2′,2′-trifluoroethyl ether or combination thereof;
wherein when the mold density of the microcellular polyurethane is about 400 kg/m³-about 700 kg/m³, the linear shrinkage of said microcellular polyurethane is 1.0%-1.5%.

In yet another aspect, the present invention discloses a method for making microcellular polyurethane, in particular microcellular polyurethane elastomers, comprising:

i) combining the following components to obtain a mixture:
a) an isocyanate with a NCO content of about 5 wt. %-30 wt. %, based on 100% by weight of the isocyanate;
b) a polyol having a functionality of 1-5, and a number average molecular weight of about 1000-12000;
c) optionally catalyst;
d) a blowing agent comprising a fluorinated ether of formula (I):

X—O—Y (I)

wherein X comprises fluorinated alkyl group of 1-6 carbon atoms, Y is independently selected from alkyl group or fluorinated alkyl group of 1-2 carbons;

wherein a boiling point of the fluorinated ether is in the range of about 0° C.-75° C.; and

ii) under suitable conditions, foaming said mixture to obtain the microcellular polyurethane.

In yet another aspect, the present invention discloses the microcellular polyurethane, especially microcellular polyurethane elastomers prepared using above-described composition, as well as the applications of such microcellular polyurethane in the preparation of carpets, rollers, sealing strips, coatings, tires, windshield wipers, steering wheels or washers.

The fluorinated ethers in the blowing system for making microcellular polyurethane of the present invention will not damage ozone layer and have a relatively low GWP (e.g. the GWP of 1,1,2,2-tetrafluoroethyl methyl ether is only 87), thus is more friendly to the environment. In addition, fluorinated ethers that are in liquid form at ambient temperature may be chosen to simplify process conditions. After foaming, such microcellular polyurethane generally exhibit linear shrinkage in the range of 0.8%-1.5%, and primarily in the range of 1%-1.25%. Therefore, when replacing HFC-134a with fluorinated ethers of the present invention as blowing agents, it is not necessary to change existing shoe sole molds; thus the existing molds and process may be conveniently applied. Furthermore, in comparison to ones made with HFC-134a, the microcellular polyurethane prepared according to the present invention has thicker surface skin, resulting in better resistance to abrasion, which is advantageous for later processing steps.

### DETAILED DESCRIPTION OF THE INVENTION

Linear shrinkage of the present invention is measured according to the following method: storing the demolded part for 24 hours at room temperature (˜23° C.) and ˜50% humidity, and comparing its length (longest dimension) with the longest dimension of the mold. Linear shrinkage values are expressed in relation to the longest dimension of the mold.

Examples of the isocyanates include but not limited to ethylene diisocyanate, 1,4-tetramethylene diisocyanate, 1,6-hexamethylene diisocyanate (HDI), 1,2-dodecane diisocyanate, cyclobutane-1,3-diisocyanate, cyclohexane 1,3- and 1,4-diisocyanates and any mixtures of these two isomeric compounds, 1-isocyanato-3,3,5-trimethyl-5-isocyanatomethyl-cyclohexane, 2,4-hexahydrotoluene diisocyanates, hexahydro-1,3- and 1,4-phenylene diisocyanate, perhydro-2,4- and 4,4-diphenylmethane diisocyanate, 1,3- and 1,4-phenylene diisocyanate, 1,4-durol diisocyanate, 1,4-stilbene diisocyanate, 3,3′-dimethyl-4,4′-biphenylene diisocyanate, toluene 2,4- and 2,6-diisocyanates (TDI) and any mixtures of these two isomeric compounds, diphenylmethane-2,4′-, 2,2′- and 4,4′-diisocyanates (MDI) and any mixtures of these three isomeric compound, and naphthylene-1,5-diisocyanate (NDI) or mixtures and combinations of any of the above isocyanates.

Said isocyanates also include the above-mentioned isocyanates modified with carbodiimide, uretoneimine, allophanate or isocyanurate structures. These modified isocyanates are, preferably but not limit to diphenylmethane diisocyanates, carbodiimide modified diphenylmethane diisocyanates, their mixtures, their isomers or mixtures of any possible isomers.

Said isocyanates may also include isocyanate prepolymer or quasi-prepolymer prepared by reacting an isocyanate compound as just described with one or more isocyanate-reactive materials to form a mixture of isocyanate-terminated prepolymer having an average—NCO content of from 5% to 30%, preferable from 10% to 25%, more preferably from 13% to 23%. An example of such polyisocyanate is Desmodur® 10IS14C, manufactured by Bayer MaterialsScience, wherein the polyisocyanate is formed by reacting MDI with polyether polyol and has an average NCO content of about 20%. NCO content refers to the weight percent of the isocyanate group in the entire isocyanate prepolymer or quasi-prepolymer, based on 100% by weight of said prepolymer or quasi-prepolymer.

Said polyols contain hydroxyl groups that react with isocyanates, and they comprise polyether polyol, polyester polyol, polycarbonate polyol, all types of polymer polyols and polyols from animal oils or plant oils and the mixtures thereof.

Suitable polyether polyols may be produced by known processes, for example, by reacting alkene oxides with starter molecules in the presence of catalysts. Said catalysts, preferably are, but not limited to alkali hydroxides, alkali alkoxides, antimony pentachloride, boron fluoride etherate or mixtures thereof. Said alkene oxides, preferably are, but not limited to tetrahydrofuran, ethylene oxide, 1,2-propylene oxide, 1,2- and 2,3-butylene oxide, styrene oxide and/or mixtures thereof. The suitable starter molecules may be selected from polyhydric compounds, such as water, ethylene glycol, 1,2- and 1,3-propanediols, 1,4-butanediol, diethylene glycol, trimethylol-propane, or mixture thereof.

Suitable polyester polyols may be produced from the reaction of organic dicarboxylic acids or dicarboxylic acid anhydrides with polyhydric alcohols. Suitable dicarboxylic acids are preferably, but not limited to aliphatic carboxylic acids containing 2 to 12 carbon atoms, which are preferably, but not limited to, succinic acid, malonic acid, glutaric acid, adipic acid, suberic acid, azelaic acid, sebacic acid, decane-dicarboxylic acid, maleic acid, fumaric acid, phthalic acid, isophthalic acid, terephthalic acid and mixtures thereof. Suitable anhydrides are preferably, but not limited to, phthalic anhydride, terachlorophthalic anhydride, maleic anhydride and mixtures thereof. Suitable polyhydric alcohols include ethanediol, diethylene glycol, 1,2- and 1,3-propanediols, dipropylene glycol, 1,3-methylpropanediol, 1,4-butanediol, 1,5-pentanediol, 1,6-hexanediol, neopentyl glycol, 1,10-decanediol, glycerol, trimethylol-propane, or mixtures thereof. Polyester polyols of lactones, for example, ε-caprolactone, can also be used.

The polycarbonate polyols comprise, but not limited to polycarbonate diols. Suitable polycarbonate diols may be prepared by reacing diols with dialkyl-carbonates, diaryl-carbonates or phosgene. Said diols, are preferably, but not limited to 1,2-propanediol, 1,3-propanediol, 1,4-butanediol, 1,5-pentanediol, 1,6-hexanediol, diethylene glycol, trioxymethylene glycol and mixtures thereof. The dialkyl- or diaryl-carbonates are preferably, but not limited to, diphenyl carbonate.

Suitable polymer polyols include dispersions of polymer particles, such as polyurea, polyurethane-urea, polystyrene, polyacrylonitrile and polystyrene-co-acrylonitrile polymer particles, in a polyol, typically a polyether polyol. Suitable polymer polyols are described in U.S. Pat. Nos. 4,581,418 and 4,574,137, incorporated by reference herein. Preferred are grafted polymer polyether polyol, particularly those based on styrene and/or acrylonitrile. The styrene and/or acrylonitrile can be obtained by in situ polymerization of styrene, acrylonitrile or the mixtures thereof. In said mixture of styrene and acrylonitrile, the ratio of styrene to acrylonitrile is 90:10-10:90, preferably 70:30-30:70. Suitable polymer polyether polyols comprise Hyperlite® E-850, manufactured by Bayer MaterialsScience, which has an average functionality of 3, a hydroxyl number of 20, and a weight ratio of the copolymer of styrene and acrylonitrile about 43 wt. %, based on the weight of polymer polyether polyol as 100 wt. %.

Polyols of the present invention comprise polyether polyols, polyester polyols polycarbonate polyols, all sorts of polymer polyols, polyols derived from animal fats or vegetable oils and mixtures thereof as described above, which have an average functionality of 2-5 and a number average molecular weight of about 1000-12000. The functionality of polyols refers to the number of active groups in the polymer that can participate in the reaction and the number average molecular weight may be determined using gel permeation chromatography (GPC). Preferred polyols include polyols and mixtures thereof as described above having an average functionality of 2˜3 and a number average molecular weight of about 2000˜7000. One type of polyols of the present invention comprises a mixture of only polyether polyols and polymer polyols. Another type of polyols of the present invention comprises at least one polymer polyether polyol. Both here and everywhere else in the current invention, “about” means an error range of 1%. For example, polyols with a number average molecular weight of about 1000˜12000 include polyols with molecular weights falling in the range between 990˜12120.

The blowing agent of the present invention comprises at least one fluorinated ether of formula (I):

X—O—Y (I)

wherein X comprises fluorinated alkyl groups of 1-6 carbon atoms, Y is independently selected from alkyl groups or fluorinated alkyl groups of 1-2 carbons and the boiling point of the fluorinated ether of formula (I) falls within the range of about 0° C.-75° C. The above-described fluorinated alkyl groups include the ones that every H atom has been replaced by F atoms.

Above-described fluorinated alkyls include the ones that are derived with any isotope of fluorine. X may be linear or branched singular or multiple fluorine-derived methyl, ethyl, propyl, butyl, amyl or hexyl groups. Y may be methyl, ethyl groups or singular or multiple fluorine-derived methyl and ethyl groups.

Boiling point is defined as the temperature at which a liquid is boiling under a standard atmosphere. The boiling points of the above fluorinated ethers may be measured using distillation methods or boiling tube method. For the purposes of simplifying process conditions and reducing the usage of fluorinated ethers, the preferred fluorinated ethers have a boiling point in the range of about 6° C.-61° C., more preferably in the range of about 15° C.-57° C., especially preferably in the range of about 37° C.-57° C.

Non-limiting examples of suitable fluorinated ethers include pentafluoroethyl methyl ether (HFE245mc, b.p. 6° C.); 2,2,2-trifluoroethyl difluoromethyl ether (HFE245mf, b.p. ° C.); 1,1,2,2-tetrafluoroethyl methyl ether (HFE254, b.p. 37° C.); 2,2,3,3,3-pentafluoropropyl difluoromethyl ether (HFE347mcf, b.p. 46° C.); 1,1,2,2-tetrafluoroethyl-2′,2′,2′-trifluoroethyl ether (HFE3400, b.p. 56° C.); nonafluorobutyl methyl ether (HFE7100, b.p. 61° C.); their isomers and any mixtures thereof.

Blowing agents of the present invention may include mixtures of water and above-described fluorinated ethers. The amount of water is usually about 0.1 wt. %-2 wt. %, and the amount of fluorinated ethers is about 0.1 wt. %-20 wt. %, preferably about 1.5 wt. %-10 wt. %, all based on the total weight of polyols as 100 wt. %.

Blowing agents of the present invention may include mixtures of hydro fluoro carbons and above-described fluorinated ethers. Suitable hydro fluoro carbons include HFC227ea (heptafluoropropane). The amount of hydro fluoro carbons is usually about 0.1 wt. %-2 wt. %, and the amount of fluorinated ethers is about 0.1 wt. %-20 wt. %, preferably about 1.5 wt. %-10 wt. %, all based on the total weight of polyols as 100 wt. %.

Mixtures of above-described fluorinated ethers with conventional physical and/or chemical blowing agents are also suitable for the present invention. Conventional physical and/or chemical blowing agents include, but not limited to water, halohydrocarbons, hydrocarbons and gases. Said halohydrocarbons, include, but not limited to monochlorodifluoro methane, dichloromonofluoro methane, trichloromonofluoro methane, 1,1,1,2-tetrafluoro ethane, heptafluoro propane or mixtures thereof. Said hydrocarbons, include, but not limited to butane, propane, cyclopropane, hexane, cyclohexane, heptane or mixtures thereof. Said gases, include, but not limited to air, CO₂ or N₂. One or more types of the above-described physical or chemical blowing agents may be combined with said fluorinated ethers in an appropriate amount. The appropriate amount of the blowing agents is determined by the desired free-rise density of the microcellular polyurethanes.

One or more catalysts are preferably present in the reactive mixture. A wide variety of materials are known to catalyze polyurethane forming reactions, including tertiary amines, tertiary phosphines, various metal chelates, acid metal salts, strong bases, various metal alcoholates and phenolates, and metal salts of organic acids. Catalysts of most importance are organotin catalysts and tertiary amine catalysts, which can be used singly or in some combination. It is usually preferred to use a combination of at least one “gelling” catalyst, which strongly promotes the reaction between an alcohol group with an isocyanate, and at least one “blowing” catalyst, which strongly promotes the reaction of an isocyanate group with a water molecule.

Examples of suitable organotin catalysts are stannic chloride, stannous chloride, stannous octoate, stannous oleate, dimethyltin dilaurate, dibutyltin dilaurate, dibutyltin dioctoate, other organotin compounds of the formula SnRn(OR₄₋ₙ, wherein R is alkyl or aryl and n is from 0 to 2, mercaptotin catalysts, and the like.

Examples of tertiary amine catalysts include: trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N, N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of such tertiary amines may also be used. The amount of the catalysts in a reaction mixture is about 0.001 wt. %-10 wt. %, based on the total weight of polyols in the reaction mixture as 100 wt. %.

The chain extenders typically are selected from compounds comprising at least two active hydrogen atoms with molecular weights lower than 800, preferably from 18 to 400. The compounds comprising at least two active hydrogen atoms are preferably, but not limit to alkanediols, dialkylene glycols, polyalkylene polyols and mixtures thereof. The examples are ethanediol, 1,4-butanediol, 1,6-hexanediol, 1,7-heptanediol, 1,8-octanediol, 1,9-nonanediol, 1,10-decanediol, diethylene glycol, dipropylene glycol, polyoxyalkylene glycols or the mixture thereof. Said compounds comprising at least two active hydrogen atoms may also include branched or unsaturated alkanediols or mixtures thereof. Examples include 1,2-propanediol, 2-methyl-1,3-propanediol, 2,2-dimethyl-1,3-propanediol, 2-butyl-2-ethyl-1,3-propanediol, 2-butene-1,4-diol, 2-butyne-1,4-diol, alkanolamines and N-alkyldialkanolamines such as ethanolamine, 2-propanolamine, 3-amino-2,2-dimethylpropanol, N-methyl and N-ethyl-diethanolamines and mixtures thereof. The compounds comprising at least two active hydrogen atoms may further include (cyclo) aliphatic and aromatic amines or their mixtures, for example 1,2 ethylenediamine, 1,3-propylenediamine, 1,4-butylenediamine, 1,6-hexamethylenediamine, isophoronediamine, 1,4-cyclohexamethylenediamine, N,N′-diethyl-phenylenediamine, 2,4- and 2,6-diaminotoluene and their mixtures. The quantity of the chain extender is about 1 wt. %-50 wt. %, based on 100% by weight of the polyol and the chain extender in the reaction mixture.

The reaction composition for preparing the polyurethane elastomers of the present invention may contain one or more crosslinkers. For purposes of this invention “crosslinkers” are materials having three or more isocyanate-reactive groups per molecule. Crosslinkers preferably contain from 3 to 8, especially from 3 to 4 hydroxyl, primary amine or secondary amine groups per molecule and have an equivalent weight of from about 30 to about 200, especially from about 50 to 125. Examples of suitable crosslinkers include diethanol amine, monoethanol amine, triethanol amine, mono-di- or tri(isopropanol) amine, glycerine, trimethylol propane, pentaerythritol, and the like. Typical quantity of crosslinkers is about 0 wt. %-20 wt. %, preferably 0.01 wt. %-10 wt. %, based on 100% by weight of the polyol in the reaction mixture.

In addition to the foregoing components, the reaction composition may contain various other optional ingredients such as surfactants; cell openers; fillers such as calcium carbonate; pigments and/or colorants such as titanium dioxide, iron oxide, chromium oxide, azo/diazo dyes, phthalocyanines, dioxazines and carbon black; reinforcing agents such as fiber glass, carbon fibers, flaked glass, mica, talc and the like; biocides; preservatives; antioxidants; flame retardants; and the like. The quantity of surfactants in the reaction composition varies according to the type of surfactants and the intended application, but is generally about 0.02 wt. %-1 wt. %, preferably 0.08 wt. %-0.3 wt. %, based on 100% by weight of the polyol in the reaction composition.

The quantity of isocyanate in the reaction composition is often expressed in terms of the NCO Index X, which is defined as:

$$X = \frac{[ \begin{matrix}the mole number of isocyanate group ( NCO \\ group ) in the isocyanante or the prepolymer\end{matrix} ]}{[ \begin{matrix}the mole number of isocyanate reactive \\ group comprised in the formulation\end{matrix} ]} \times 100$$

The NCO Index of the present invention is typically about 80-140, more particularly about 90-120. For the manufacturing of shoe soles, the preferred NCO Index is about 95-105.

In general, the microcellular polyurethane is prepared by mixing the polyisocyanate and polyol components in the presence of blowing agents, and optionally the catalyst(s), surfactant(s) and other auxiliary agents. The resulting reaction composition is placed into a closed mold and subjected to conditions so that the polyisocyanate, blowing agents containing fluorinated ether and polyol react to form microcellular polyurethane elastomers.

It is generally preferred to pre-mix said polyol, blowing agents, chain extenders, catalysts and other desired components (in particular at least one surfactant) into a formulated polyol component. This formulated polyol component is then mixed with the polyisocyanate and the resulting mixture introduced into the mold. It is possible to bring the individual components individually, or in various admixtures, to a mixing head for mixing and dispensing.

The mold and/or the reactive composition may be preheated if desired, but this is not required in all cases. The mold containing the reactive composition may be heated after the reactive mixture is charged to the mold. If heating is used, the temperature range is usually about 45° C.-60° C.

The reaction composition is maintained in the mold until it cures sufficiently that it can be demolded without becoming permanently distorted or damaged.

To persons skilled in the art, relevant polyurethane foaming technology and apparatus are well-known. For information, on can refer to literatures including “Polyurethane Chemistry and Process” authored by Saunders and Fish (2^{nd} part); “Polyurethane Handbook” authored by Oertel (published September 1992) and “Polyurethane foam plastics” authored by Zhu, Lvmin (3^{rd} edition, published January 2005), all incorporated by reference herein.

In the present invention, free rise density is defined as the density of microcellular polyurethane when it foams and cures only under atmospheric pressure. The amount of various components in the reactive composition may be adjusted based on desired free rise density. Mold density is defined as the density of microcellular polyurethane when it is foamed and cured in a closed mold, and the ratio of mold density over free rise density is defined as a packing ratio. Suitable microcellular polyurethane of the present invention generally has a free rise density of about 270 kg/m³. Suitable microcellular polyurethane of the present invention generally has a mold density of about 150-about 900 kg/m³, preferably of about 200-about 800 kg/m³, more preferably of about 400-about 700 kg/m³, corresponding to a packing ratio of about 1.5-about 3.0, more preferably about 1.85-2.4, respectively.

The physical properties of the microcellular polyurethane elastomers of the present invention may be measured with conventional methods well known in the field.

The density of the microcellular polyurethane elastomer is measured according to method DIN EN ISO 845.

The hardness of the microcellular polyurethane elastomer is measured according to method DIN 53505.

The tensile strength of the microcellular polyurethane elastomer is measured according to method DIN E53504.

The elongation of the microcellular polyurethane elastomer is measured according to method DIN 53504.

The tear strength of the microcellular polyurethane elastomer is measured according to method DIN ISO 34.

One advantage of the invention is that when use fluorinated ethers, which are more environmental-friendly than HFC134a, as blowing agents, the polyurethane shoe soles obtained possess a linear shrinkage similar to that obtained with HFC134a as blowing agents. This property is very important to shoe manufacturers because it allows them to continue using the mold designed for formulations containing HFC134a, which translates to significant cost saving. For microcellular polyurethane elastomers having a mold density of about 400-700 kg/m³, measured with the method described previously, their linear shrinkage is generally about 1.0-1.5%.

Another advantage of the present invention is the use of fluorinated ethers having boiling points in the range of about 0° C.-75° C., preferably in the range of about 6° C.-61° C., more preferably in the range of about 15° C.-57° C., even more preferably in the range of 37° C.-57° C. as blowing agents. Skilled persons in the art may choose fluorinated ethers that are in liquid form under ambient temperature and pressure according to their applications, thus simplify the required process conditions.

Yet another advantage of the present invention is that in comparison to polyurethane shoe soles made with HFC134a as blowing agent, the microcellular polyurethane elastomers of the present invention exhibit similar or better physical properties, in particular having thicker surface skin, thus they possess improved resistance to abrasion.

Microcellular polyurethane of the present invention may also be applied in the preparation of carpets, rollers, sealing strips, coatings, tires, windshield wipers, steering wheels or washers and etc.

The examples below are for illustration purposes only, and are not meant to limit the scope of the present invention. Unless otherwise stated, all parts by weight refer to the ratio of the weight of various components. Skilled persons in the art are familiar with the calculation of weight percent of various components based on the weight of polyol as 100 wt. % using respective parts by weight.

### EXAMPLE

### Materials and Reagents

| | |
|---|---|
| ISO 1 | Desmodur ® 10IS14C, an NCO terminated polyisocyanate |
| | prepolymer of polyether and MDI; the NCO group is about 20 wt. |
| | %, based on the weight of polyisocyanate prepolymer as 100 wt. |
| | %. Obtained from Bayer MaterialsScience. |
| Polyol 1 (Bayflex ® | Polyether polyols that are polymerization products of ethylene |
| 0650) | oxide or propylene oxide, having a functionality of 2 and a |
| | number average molecular weight of about 4000. Obtained |
| | from Bayer MaterialsScience. |
| Polyol 2 (Hyperlite ® | Polymer polyether polyol, wherein the |
| E-850) | polystyrene-co-acrylonitrile is about 43 wt. %, based on the |
| | weight of polymer polyether polyol as 100 wt. %. |
| | Functionality is 3 and is obtained from Bayer MaterialsScience. |
| Polyol 3 (Arcol ® | Polyether polyols that are polymerization products of ethylene |
| 1362) | oxide or propylene oxide, having a functionality of 3 and a |
| | number average molecular weight of about 6000. Obtained |
| | from Bayer MaterialsScience. |
| Polyol 4 (SBU ® | Polyether polyols that are polymerization products of ethylene |
| S240) | oxide or propylene oxide, having a functionality of 3 and a |
| | number average molecular weight of about 4800. Obtained |
| | from Bayer MaterialsScience. |
| BDO | Chain extender, 1,4-butanediol, functionality = 2, obtained from |
| | Shanghai GaoXin Chemical and Glass Equipment Company |
| Dabco ® S-25 | Amine catalyst, including triethylenediamine (25 wt. %) and |
| | 1,4-butanediol (75 wt. %); obtained from Air Products |
| Dabco ® 1028 | Tertiary amine catalyst, obtained from Air Products. |
| Fomrez ® UL-1 | Organotin catalyst, obtained from Momentive |
| Dabco ® DC-198 | Silicone surfactant, obtained from Air Products |
| HFC134a | Hydrofluorocarbon type of blowing agent, 1,1,1,2-tetrafluoro |
| | ethane (FCH₂CF₃), obtained from Sovlay |
| HFC227ea | Hydrofluorocarbon type of blowing agent, heptafluoro propane |
| | (CF₃CHFCF₃), obtained from Sovlay |
| HFE254 | Fluorinated ether type of blowing agent, |
| | 1,1,2,2-tetrafluoroethylmethyl ether (CH₃—O—CF₂CF₂H), |
| | obtained China Fluoro Technology Co., Ltd |
| HFE3400 | Fluorinated ether type of blowing agent, 1,1,2,2-tetrafluoro |
| | ethyl-2,2,2-trifluoroethyl ether (CF₂HCF₂OCH₂CF₃) obtained |
| | from TOP FLUOROCHEM., Ltd |
| HFE7200 | Fluorinated ether type of blowing agent, nonafluorobutyle ethyl |
| | ether (C₄F₉OC₂H₅), obtained from 3M Inc. |

The comparative and working examples of the present invention were all prepared according to the following method: except for isocyanates (including polyisocyanate prepolymer), mix the rest ingredients (including polyol, catalysts, blowing agents or optionally other components) together to form a formulated polyol component, stir at a speed of about 1400 rpm until the formulated polyol component is homogeneous.

The above formulated polyol component may be combined with isocyanates for reaction using one of the two following methods: the first method is to bring the formulated polyol component and isocyanates into a mixture for reaction with a stirrer; the second method is to react the formulated polyol component with isocyanates in a dual- or multi-components polyurethane mixing apparatus. Such mixing apparatus may be high pressure or low pressure, preferably a low pressure mixing apparatus. The mixing process may be conducted with two streams or multiple streams. For example, pigments may be introduced into the mixing apparatus via a third stream in order to rapidly change the color of the mixture. A PENDRAULIK mixing apparatus obtained from PENDRAULIK Corp. was used in all the experiments.

The polyurethane elastomers in all working examples and comparative examples below had the same free rise density of 270 kg/m³. Skilled persons in the art are familiar with how to obtain desired free rise density through adjusting NCO index.

### Comparative Example 1

This comparative example used water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of comparative example 1.

| Component | Parts by Weight |
|---|---|
| Polyol 1 | 6 |
| Polyol 2 | 6 |
| Polyol 3 | 67.9 |
| 1,4-butanediol | 9 |
| Dabco ® S-25 | 1.0 |
| Dabco ® 1028 | 0.4 |
| Dabco ® DC-198 | 0.2 |
| Fomrez ® UL-1 | 0.02 |
| water | 0.29 |
| ISO 1 | 59.1 (NCO Index 96) |

As an example, the weight percent of water in respect to the weight of all polyols as 100 wt. % may be calculated using the following equation:

$$\begin{matrix}water wt . \% = [ ( parts by weight of water ) / \\ ( the sum of parts by weight of all polyols ) ] \times \\ 100 \% \\ = [ 0.29 / ( 6 + 6 + 67.9 ) ] \times 100 \% \\ = 0.36 wt . \%\end{matrix}$$

The above calculation may be applied to the determination of the weight content for all other components in the working and comparative examples of the present invention.

### Comparative Example 2

This comparative example used the mixture of hydrofluoro carbon 1,1,1,2-tetrafluoro ethane (HFC134a) and small amount of water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of comparative example 2.

| Component | Parts by Weight |
|---|---|
| Polyol 1 | 6 |
| Polyol 2 | 6 |
| Polyol 3 | 67.9 |
| 1,4-butanediol | 9 |
| Dabco ® S-25 | 1.0 |
| Dabco ® 1028 | 0.4 |
| Dabco ® DC-198 | 0.2 |
| Fomrez ® UL-1 | 0.02 |
| water | 0.06 |
| HFC134a | 1.0 |
| ISO 1 | 54.2 (NCO Index 96) |

### Comparative Example 3

This comparative example used the mixture of a fluorinated ether—nonafluorobutyle ethyl ether(C₄F₉OC₂H₅) having a boiling point of 76° C. and small amount of water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of comparative example 3.

| Component | Parts by Weight |
|---|---|
| Polyol 1 | 6 |
| Polyol 2 | 6 |
| Polyol 3 | 67.9 |
| 1,4-butanediol | 9 |
| Dabco ® S-25 | 1.0 |
| Dabco ® 1028 | 0.4 |
| Dabco ® DC-198 | 0.2 |
| Fomrez ® UL-1 | 0.02 |
| water | 0.19 |
| HFE7200 | 7.0 |
| ISO 1 | 54.2 (NCO Index 96) |

### Example 1

This example used a fluorinated ether-1,1,2,2-tetrafluoroethyl methyl ether (HFE254) having a boiling point of 37° C. as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of example 1.

| Component | Parts by Weight |
|---|---|
| Polyol 1 | 6 |
| Polyol 2 | 6 |
| Polyol 3 | 67.9 |
| Polyol 4 | 5 |
| 1,4-Butanediol | 9 |
| Dabco ® S-25 | 1.0 |
| Dabco ® 1028 | 0.4 |
| Dabco ® DC-198 | 0.2 |
| Fomrez ® UL-1 | 0.02 |
| HFE254 | 4.8 |
| ISO 1 | 53.4 (NCO Index 96) |

### Example 2

This example used the mixture of a fluorinated ether-1,1,2,2-tetrafluoroethyl methyl ether (HFE254) having a boiling point of 37° C. and small amount of water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of example 2.

| Component | Parts by Weight |
|---|---|
| Polyol 1 | 6 |
| Polyol 2 | 6 |
| Polyol 3 | 67.9 |
| 1,4-butanediol | 9 |
| DabcoS-25 | 1.0 |
| Dabco 1028 | 0.4 |
| Dabco DC-198 | 0.2 |
| Fomrez UL-1 | 0.02 |
| water | 0.19 |
| HFE254 | 3.0 |
| ISO 1 | 56.9 (NCO Index 96) |

### Example 3

This example used the mixture of a fluorinated ether 1,1,2,2-tetrafluoroethyl-1′,1′,1′-trifluoroethyl ether (HFE3400) having a boiling point of 56° C. and small amount of water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of example 3.

| Component | Parts by Weight |
|---|---|
| Polyol 1 | 6 |
| Polyol 2 | 6 |
| Polyol 3 | 67.9 |
| 1,4-Butanediol | 9 |
| DabcoS-25 | 1.0 |
| Dabco 1028 | 0.4 |
| Dabco DC-198 | 0.2 |
| Fomrez UL-1 | 0.02 |
| water | 0.25 |
| HFE3400 | 1.5 |
| ISO 1 | 58.2 (NCO Index 96) |

### Example 4

This example used the mixture of a fluorinated ether-1,1,2,2-tetrafluoroethyl methyl ether (HFE254) having a boiling point of 37° C., a hydrofluoro carbon—heptafluoro propane (HFC227ea) and small amount of water as the blowing agent. All components listed in the table below, except for isocyanate (ISO 1), were mixed together through stirring at 1400 rpm to form a formulated polyol component. The formulated polyol component was then mixed with ISO 1 at a stirring speed of 4200 rpm at 25° C., the reaction mixture was then immediately transferred to a mold heated to about 50° C. The mold was closed, the foam cured and then demolded after 5 minutes to obtain the microcellular polyurethane elastomer of example 4.

| Component | Parts by weight |
|---|---|
| Polyol 1 | 6 |
| Polyol 2 | 6 |
| Polyol 3 | 67.9 |
| 1,4-butandiol | 9 |
| DabcoS-25 | 1.0 |
| Dabco 1028 | 0.4 |
| Dabco DC-198 | 0.2 |
| Fomrez UL-1 | 0.02 |
| water | 0.25 |
| HFE254 | 1.5 |
| HFC227ea | 0.2 |
| ISO 1 | 58.2 (NCO index 96) |

The reaction components of above comparative examples 1-3 and examples 1-4 can all form microcellular polyurethane elastomers having a free rise density of about 270 kg/m³. Three molded products of various packing ratios—about 1.9, 2.0 and 2.4, respectively, were prepared with each type of reaction component in a stainless steel mold of 20 cm×20 cm×1 cm; therefore resulted in microcellular elastomers with a mold density of 500, 550 and 650 kg/m³, respectively. After demolding, the elastomers were cured for 24 hours at 23° C. and a relative humidity of 50%. The length (longest dimension) of the elastomer was then compared to the length (longest dimension) of the mold and linear shrinkage values are expressed in relation to the longest dimension of the mold.

| Mold | Linear Shrinkage (%) | | | | | | |
|---|---|---|---|---|---|---|---|
| Density | Comp. | Comp. | Comp. | | | | |
| (kg/m³) | Example 1 | Example 2 | Example 3 | Example 1 | Example 2 | Example 3 | Example 4 |
| 500 | 0.7 | 1.25 | 1.75 | 1.5 | 1.25 | 1.25 | 1.25 |
| 550 | 0.5 | 1.25 | 1.75 | 1.25 | 1.25 | 1.25 | 1.25 |
| 650 | 0.4 | 1.0 | 1.5 | 1.0 | 1.0 | 1.0 | 1.0 |

For the tested mold densities, the microcellular polyurethane prepared with blowing agent only containing water had linear shrinkage of about 0.4%˜0.7%, which was significantly lower than the linear shrinkage (1.0%˜1.25%) of those made with HFC134a as a blowing agent; therefore cannot satisfy the need of the shoe manufacturers of not acquiring new shoe molds. Similarly, for some commonly-used mold density, the microcellular polyurethane prepared with blowing agents comprising a mixture of a fluorinated ether HFE7200 having a boiling point of 76° C. and water exhibit a linear shrinkage beyond the range of 1.0%˜1.5%, which is acceptable to shoe manufacturers. In contrast, when the fluorinated ethers of the present invention were used as blowing agents, regardless of being used alone, or in combination with small amount of water, or in combination with both water and hydrofluoro carbon HFC227ea, under all mold densities being tested, the produced microcellular polyurethane all exhibit linear shrinkage in the range of 1.0%˜1.5%. Thus the shoe manufacturers do not need to change shoe molds and can save production cost.

It is understood by persons skilled in the art that the present invention is not limited to the above specifics, and when not deviating from the spirit or main characteristics of the present invention, it may be carried out in other forms. Therefore from every aspect, the above examples shall be construed as illustrative, and not limiting. Thus the scope of the invention shall be defined by the claims and not the above description. And any modification, as long as it falls into the meaning and scope of an equivalent to what is claimed, shall be considered as the present invention.

1.-35. (canceled)

36. A composition for preparing microcellular polyurethane, comprising:
a) an isocyanate having an NCO content of from about 5 weight % to about 30 weight %, based on 100% by weight of the isocyanate;
b) a polyol having a functionality of from 1 to 5 and a number average molecular weight of from about 1000 to about 12000;
c) optionally a catalyst; and
d) a blowing agent comprising a fluorinated ether of formula (I):
X—O—Y (I)
wherein,
X is a fluorinated alkyl group of from 1 to 6 carbon atoms;
Y is an alkyl group or a fluorinated alkyl group containing 1 to 2 carbons;
and the boiling point of said fluorinated ether is in the range of from about 0° C. to about 75° C.

37. The composition of claim 36, wherein the boiling point of said fluorinated ether is in the range of from about 6° C. to about 61° C.

38. The composition of claim 37, wherein the boiling point of said fluorinated ether is in the range of from about 15° C. to about 57° C.

39. The composition of claim 38, wherein the boiling point of the fluorinated ether is in the range of from about 37° C. to about 57° C.

40. The composition of claim 36, wherein the polyol has a functionality of from 2 to 3 and a number average molecular weight of from about 2000 to 7000.

41. The composition of claim 36, wherein the fluorinated ether comprises 1,1,2,2-tetrafluoroethyl methyl ether.

42. The composition of claim 36, wherein the fluorinated ether comprises 1,1,2,2-tetrafluoroethyl-2′,2′,2′-trifluoroethyl ether.

43. The composition of claim 36, wherein the fluorinated ether comprises a mixture of 1,1,2,2-tetrafluoroethyl methyl ether and 1,1,2,2-tetrafluoroethyl-2′,2′,2′-trifluoroethyl ether.

44. The composition of claim 36, wherein the NCO content of the isocyanate is from about 15 weight % to about 25 weight %, based on 100% by weight of the isocyanate.

45. The composition of claim 36, wherein the blowing agent comprises a mixture of water and said fluorinated ether.

46. The composition of claim 36, wherein the blowing agent further comprises water, a halogenated alkane, a hydrocarbon, a gas, or combinations thereof.

47. The composition of claim 46, wherein said halogenated alkane comprise heptafluoro-propane.

48. The composition of claim 36, wherein the catalyst comprises, an amine catalyst, an organotin catalyst, or combinations thereof.

49. The composition of claim 36, further comprising a chain extender, a cross-linker, a surfactant, a filler, a pigment, or combinations thereof.

50. The composition of claim 36, wherein the NCO index is from 80 to 120.

51. The composition of claim 50, wherein the NCO index is from 90 to 110.

52. The composition of claim 51, wherein the NCO index is from 95 to 100.

53. The composition of claim 36, wherein the content of said blowing agent is from about 0.1 weight % to about 20 weight %, based on 100% by weight of the polyol.

54. The composition of claim 36, wherein the mold density of the microcellular polyurethane is from about 150 kg/m³ to about 900 kg/m³ and the linear shrinkage of the microcellular polyurethane is from 1.0% to 1.5%.

55. The composition of claim 54, wherein the mold density of the microcellular polyurethane is from about 200 kg/m³ to about 800 kg/m³ and the linear shrinkage of the microcellular polyurethane is from 1.0% to 1.5%.

56. The composition of claim 55, wherein the mold density of the microcellular polyurethane is from about 400 kg/m³ to about 700 kg/m³ and the linear shrinkage of said microcellular polyurethane is 1.0% to 1.5%.

57. A composition for preparing microcellular polyurethane, comprising:
a) an isocyanate having an NCO content of from 15 weight % to 25 weight %, based on 100% by weight of the isocyanate;
b) a polyol having a functionality of from 2 to 3 and a number average molecular weight of from about 2000 to about 7000;
c) optionally an amine catalyst, an organotin catalyst, or a combination thereof; and
d) a blowing agent comprising 1,1,2,2-tetrafluoroethyl methyl ether,1,1,2,2-tetrafluoroethyl-2′,2′,2′-trifluoroethyl ether, or combinations thereof;
wherein when the mold density of the microcellular polyurethane is from about 400 kg/m³ to about 700 kg/m³ and the linear shrinkage of said microcellular polyurethane is from 1.0% to 1.5%.

58. A method for preparing microcellular polyurethane, comprising:
i) combining the following components to obtain a mixture:
a) an isocyanate having an NCO content of from about 5 weight % to about 30 weight %, based on 100% by weight of the isocyanate;
b) a polyol having a functionality of from 1 to 5 and a number average molecular weight of from about 1000 to 12000;
c) optionally a catalyst; and
d) a blowing agent comprising a fluorinated ether of formula (I):
X—O—Y (I)
wherein
X comprises a fluorinated alkyl group of from 1 to 6 carbon atoms; and
Y is an alkyl group or a fluorinated alkyl group containing 1 to 2 carbons;
and the boiling point of the fluorinated ether is in the range of from about 0° C. to 75° C.; and
ii) foaming said mixture, to obtain the microcellular polyurethane.

59. The method of claim 58, wherein the boiling point of the fluorinated ether is in the range of from about 6° C. to about 61° C.

60. The method of claim 59, wherein the boiling point of the fluorinated ether is in the range of from about 37° C. to about 57° C.

61. The method of claim 58, wherein the fluorinated ether comprises 1,1,2,2-tetrafluoroethyl methyl ether, 1,1,2,2-tetrafluoroethyl-2′,2′,2′-trifluoroethyl ether, or combinations thereof.

62. The method of claim 58, wherein the polyol has a functionality of from 2 to 3 and a number average molecular weight of about 2000 to 7000.

63. The method of claim 58, wherein the blowing agent comprises a mixture of water and the fluorinated ether.

64. The method of claim 58, wherein the blowing agent further comprises water, a halogenated alkane, a hydrocarbon, a gas, or combinations thereof.

65. The method of claim 64, wherein the halogenated alkane comprises heptafluoro-propane.

66. The method of claim 58, wherein the composition further comprises a chain extender, a cross-linker, a surfactant, a filler, or a pigment.

67. The method of claim 58, wherein the content of the blowing agent is from about 0.1 weight % to about 20 weight %, based on 100% by weight of the polyol.

68. A microcellular polyurethane prepared from the composition of claim 36.

69. A carpet, roller, sealing strip, coating, tire, windshield wiper, steering wheel, or washer prepared from the microcellular polyurethane of claim 68.

70. A shoe material prepared from the microcellular polyurethane of claim 68.
